(19) United States
(12) Patent Application Publication
(10) Pub. No.: US 2019/0141567 A1
(43) Pub. Date: May 9, 2019

(54) Uplink Data Compression Transaction Flow

(71) Applicant: MEDIATEK INC., Hsinchu (TW)

(72) Inventors: Yung-Hsiang Liu, Hsinchu (TW); Chia-Chun Hsu, Hsinchu (TW); Yih-Shen Chen, Hsinchu (TW)

(21) Appl. No.: 16/178,769

(22) Filed: Nov. 2, 2018

Related U.S. Application Data
(60) Provisional application No. 62/581,836, filed on Nov. 6, 2017.

(51) Int. Cl. H04W 28/06; H04L 29/06

(52) U.S. Cl. CPC H04W 28/06; H04L 69/04; H04W 80/08; H04L 69/163; H04L 69/22

(57) ABSTRACT

A method of uplink data compression (UDC) error handling is proposed to handle UDC error and to maintain compression memory synchronization between a transmitter and a receiver. Specifically, UDC checksum operation is proposed to maintain compression memory synchronization between compressor at the transmitter and decompressor at the receiver. The transmitter attaches a checksum to each UDC packet and keeps processed uncompressed data in a compression memory. The receiver decompresses each UDC packet and keeps processed uncompressed data in a compression memory. If the UDC compression memory is unsynchronized and a checksum mismatch is detected, the receiver sends an error indication to the transmitter, which resets its compression memory. The transmitter sends a reset indication to the receiver to reset its compression memory. The UDC compression memory is re-synchronized and UDC is restarted from the beginning.

### CROSS REFERENCE TO RELATED APPLICATIONS

This application claims priority under 35 U.S.C. § 119 from U.S. Provisional Application No. 62/581,836 entitled “UDC Transaction Flow” filed on Nov. 6, 2017, the subject matter of which is incorporated herein by reference.

### TECHNICAL FIELD

The disclosed embodiments relate generally to wireless communication, and, more particularly, to data for Uplink Data Compression (UDC) transaction flow with UDC checksum and error handling.

### BACKGROUND

Mobile data usage has been increasing at an exponential rate in recent year. A Long-Term Evolution (LTE) system offers high peak data rates, low latency, improved system capacity, and low operating cost resulting from simplified network architecture. In LTE systems, an evolved universal terrestrial radio access network (E-UTRAN) includes a plurality of base stations, such as evolved Node-B's (eNBs) communicating with a plurality of mobile stations referred as user equipment (UEs). Due to the steep increase in mobile traffic over the past years, there have been many attempts in finding new communication technologies to further improve the end-user experience and system performance of the mobile networks. The traffic growth has been mainly driven by the explosion in the number of connected devices, which are demanding more and more high-quality content that requires very high throughput rates.

Uplink data compression (UDC) is a method to improve uplink capacity by compressing uplink (UL) data. For UDC, many compression algorithms can be applied. For example, two different UDC compression algorithms are described in RFC1951 DEFLATE and RFC1950 ZLIB. UDC uses dictionary-based compression method. At the transmitter side, the UDC compressor keeps processed uncompressed data in its compression memory; at the receiver side, the UDC decompressor also keeps processed uncompressed data in its own compression memory. The decompressor fails to decompress upcoming compressed data packet once the compression memory is asynchronous. Under normal condition, the compression memory between the transmitter and the receiver is synchronized when UDC is configured. However, the compression memory may become asynchronous due to asynchronous or erroneous memory operation, or due to compressed packet is dropped, e.g., by a packet data convergence protocol (PDCP) discard timer. A method is desired to handle UDC error and to maintain compression memory synchronization.

### SUMMARY

A method of uplink data compression (UDC) error handling is proposed to handle UDC error and to maintain compression memory synchronization between a transmitter and a receiver. Specifically, UDC checksum operation is proposed to maintain compression memory synchronization between compressor at the transmitter and decompressor at the receiver. At the TX, the transmitter attaches a checksum to each UDC packet and keeps processed uncompressed data in a compression memory. At the RX, the receiver decompresses each UDC packet and keeps processed uncompressed data in a compression memory and detects checksum mismatch. If the UDC compression memory is unsynchronized and a checksum mismatch is detected, the receiver sends an error indication to the transmitter, which resets its compression memory. The transmitter sends a reset indication to the receiver to reset its compression memory. The UDC compression memory is re-synchronized and UDC is restarted from the beginning.

In one embodiment, a transmitting device generates uplink data compression (UDC) compressed data packets. Each corresponding uncompressed data packet is pushed into a UDC compression buffer. The TX device transmits the UDC compressed data packets to a receiving device. Each UDC compressed data packet comprises a UDC header with a checksum. The TX device receives an error indication from the receiving device indicating a checksum mismatch. The TX device then resets the UDC compression buffer upon receiving the error indication and restarts UDC for subsequent data packets.

In another embodiment, a receiving device receives uplink data compression (UDC) compressed data packets. Each UDC compressed data packet comprises a UDC header with a checksum. The RX device decompresses the UDC compressed data packets. Each corresponding uncompressed data packet is pushed into a UDC compression buffer. The RX device transmits an error indication to indicate an error of a UDC compressed data packet upon detecting a checksum mismatch. The RX device receives a subsequent UDC compressed data packet comprising a reset indication and in response resets the UDC compression buffer.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a mobile communication network with a user equipment (UE) and a base station supporting uplink data compression (UDC) in accordance with embodiments of the current invention.

FIG. 2 illustrates a simplified block diagram of a UE supporting UDC in accordance with embodiments of the current invention.

FIG. 3 illustrates a sequence flow between a UE and a base station of UDC error handling in accordance with embodiments of the current invention.

FIG. 4 illustrates examples of a UDC data packet from a transmitter and a PDCP control PDU from a receiver for UDC error handling.

FIG. 5 illustrates a UDC error handling procedure between a transmitter and a receiver through UDC checksum and UDC compression memory synchronization.

FIG. 6 illustrates one embodiment of TCP ACK packet prioritization with UDC bypass.

FIG. 7 is a flow chart of a method of UDC error handling from transmitter perspective in accordance with one novel aspect.

FIG. 8 is a flow chart of a method of UDC error handling from receiver perspective in accordance with one novel aspect.

### DETAILED DESCRIPTION

Reference will now be made in detail to some embodiments of the invention, examples of which are illustrated in the accompanying drawings.

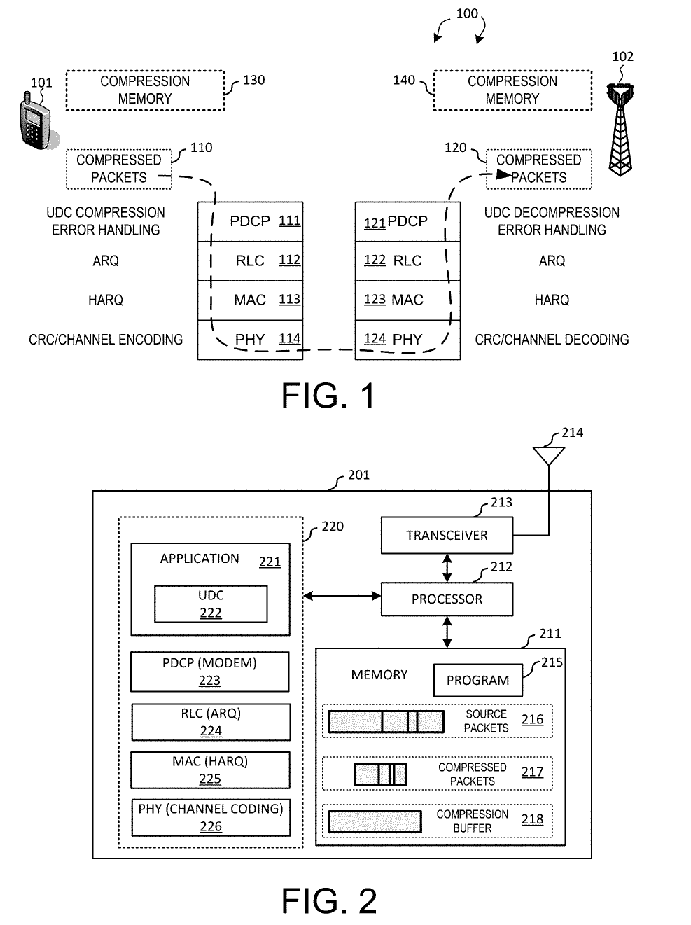

FIG. 1 illustrates a mobile communication network 100 with a user equipment (UE) 101 and a base station 102 supporting uplink data compression (UDC) in accordance with embodiments of the current invention. Mobile communication network 100 comprises a user equipment UE 101 and a serving base station BS 102. UE 101 is configured with uplink data compression (UDC) to improve uplink capacity by compressing uplink (UL) data. UDC uses dictionary-based compression method. At the transmitter side, e.g., UE 101, the UDC compressor keeps processed uncompressed data in its compression memory 130; at the receiver side, e.g., BS 102, the UDC decompressor also keeps processed uncompressed data in its own compression memory 140. The decompressor fails to decompress upcoming compressed data packet once the compression memory is asynchronous. Under normal condition, the compression memory between UE 101 and BS 102 is synchronized when UDC is configured. However, the compression memory become asynchronous due to asynchronous or erroneous memory operation, or due to compressed packet is dropped, e.g., by a packet data convergence protocol (PDCP) discard timer.

In accordance with a novel aspect, a method of UDC error handling is proposed to handle UDC error and to maintain compression memory synchronization. To facilitate UDC transaction between transmitter and receiver, the following designs are considered: 1) error handling to maintain compression memory synchronization between TX and RX; and 2) procedure flow for processing compressed and uncompressed packets for both TX and RX. Specifically, UDC checksum operation is proposed to maintain compression memory synchronization between compressor at TX and decompressor at RX.

In the example of FIG. 1, UE 101 is transmitting uplink data to be received by BS 102. At the TX side, application layer prepares data packets to be transmitted to BS 102 over lower layers. In PDCP layer 111, data packets are compressed by UDC, and compressed UDC packets 110 are transmitted over radio link control acknowledge mode (RLC AM) bearer by RLC layer 112 to ensure correctness. RLC layer packets is further transmitted over MAC layer 113 and PHY layer 114. At the RX side, BS 102 receives the data packets over PHY layer 124, MAC layer 123, RLC layer 122, and PDCP layer 121. BS 102 decompresses the compressed UDC packets 120 and deliver to higher application layer.

Different layers apply different error handling schemes to ensure proper packet delivery. For example, PHY layer applies cyclic redundancy check (CRC) error detection and channel encoding/decoding, MAC layer applies Hybrid automatic repeat request (HARQ) forward error checking and ARQ error control, RLC layer applies ARQ which provides error correction by retransmission in AM. In PDCP layer, if UDC is configured, then UDC layer error handling is applied through UDC checksum to maintain compression memory synchronization between TX and RX.

Specifically, at UE 101, each UDC packet is attached with a checksum. UE 101 also keeps processed uncompressed data in its compression memory 130. At BS 102, each UDC packet is decompressed. BS 102 also keeps processed uncompressed data in its own compression memory 140 and detects checksum mismatch. If checksum mismatch is detected, it means that compression memory 130 and 140 become unsynchronized. As a result, BS 102 would fail to decompress upcoming UDC packets. BS 102 sends an error indication to UE 101, which resets the compression memory 130. UE 101 then sends a reset indication to BS 102 to reset the compression memory 140. At this point, UDC compression memory is re-synchronized and UE 101 and BS 102 starts over UDC from the beginning.

FIG. 2 illustrates a simplified block diagram of a UE 201 supporting UDC in accordance with embodiments of the current invention. UE 201 has radio frequency (RF) transceiver module 213, coupled with antenna 214 receives RF signals from antenna 214, converts them to baseband signals and sends them to processor 212. RF transceiver 213 also converts received baseband signals from the processor 212, converts them to RF signals, and sends out to antenna 214. Processor 212 processes the received baseband signals and invokes different functional modules to perform features in UE 201. Memory 211 stores program instructions 215 and data to control the operations of UE 201. The program instructions and data 215, when executed by processor 212, enables UE 201 to carry out embodiments of the current invention. Suitable processors include, by way of example, a special purpose processor, a digital signal processor (DSP), a plurality of microprocessors, one or more microprocessors associated with a DSP core, a controller, a microcontroller, Application specific integrated circuits (ASICs), Field programmable gate array (FPGAs) circuits, and other type of integrated circuit (IC), and/or state machine.

UE 201 also includes multiple function modules and circuits that carry out different tasks in accordance with embodiments of the current invention. The functional modules and circuits can be implemented and configured by hardware, firmware, software, and any combination thereof. A processor in associated with software may be used to implement and configure features of UE 201. In one embodiment, the functional modules and circuits 220 comprise an application module 221 including a UDC layer entity 222 for UDC compression and decompression, a PDCP layer entity 223 for PDCP layer functionalities including ciphering and header compression, an RLC layer entity 224 for RLC AM delivery with ARQ, a MAC layer entity 225 with HARQ, and a PHY layer entity 226 supporting CRC and channel encoding/decoding.

In one example, Application module 221 prepares data packets to be compressed by UDC entity 222 to be passed to PDCP entity 223, and the compressed PDCP/UDC packets are transmitted over RLC AM bearer, which are then transmitted over MAC layer and PHY layer. Memory 211 comprises buffer 216 for storing a stream of uncompressed source packets and buffer 217 for storing a stream of UDC compressed packets. In addition, memory 221 comprises a UDC compression memory/buffer 218, which acts as a first in first out (FIFO) buffer. The input data of the UDC compression memory/buffer 218 is the stream of uncompressed packets, which is used for UDC checksum calculation. In one advantageous aspect, each UDC compressed packet is attached with a checksum. A receiver also maintains a UDC compression memory/buffer, which is used for deriving the checksum. The compression memory is synchronized initially between UE 201 and the receiver when UDC is configured. Later, the compression memory become unsynchronized due to erroneous memory operation or PDCP packet dropping. The receiver then detects a checksum mismatch and notifies UE 201. In response, UE 201 resets its compression memory 218, re-starts UDC compression, and notifies the receiver. As a result, the UDC compression memory between UE 201 and the receiver are re-synchronized.

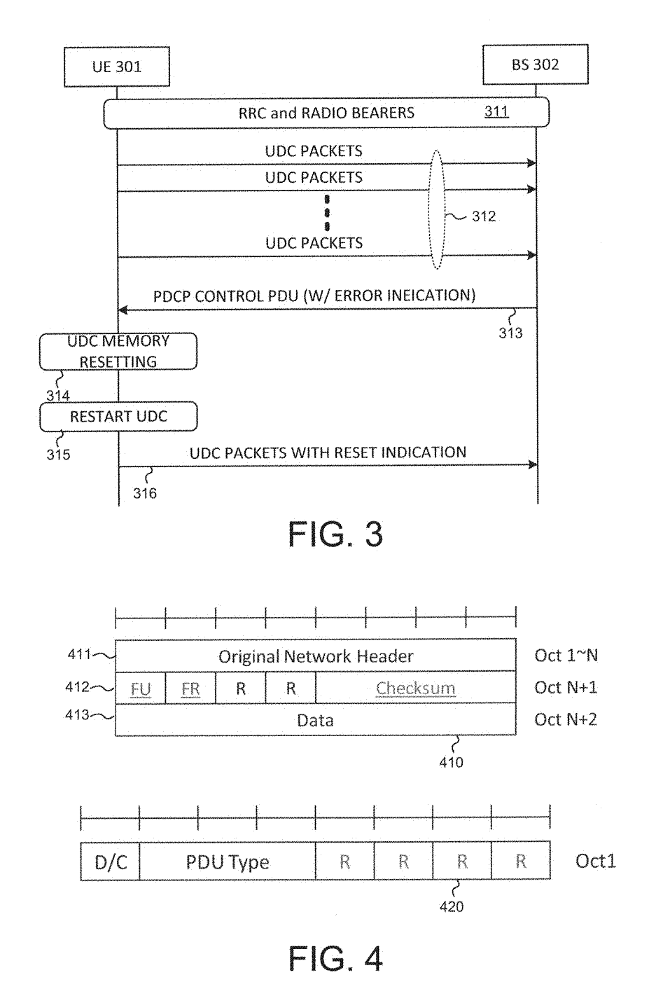

FIG. 3 illustrates a sequence flow between a UE 301 and a base station BS 302 of UDC error handling in accordance with embodiments of the current invention. In step 311, UE 301 and BS 302 establishes radio resource control (RRC) connection for control signaling and radio bearers for data connection. In step 312, UE 301 sends compressed UDC packets to BS 302. The UDC compression memory between UE 301 and BS 302 are synchronized when UDC is configured. In one example, the size of the UDC compression memory is configured by BS 302 via RRC signaling. At the transmitter, UE 301 derives a checksum from its own compression memory and attaches the checksum to each UDC compressed packet. At the receiver, BS 302 receives each compressed UDC packet and compares the received checksum and the checksum derived from its own compression memory.

In step 313, BS 302 detects a checksum mismatch and sends a PDCP control PDU to UE 301. The PDCP control PDU comprises an error indication, indicating that an UDC error has occurred and the compression memory between the sender and the receiver are unsynchronized. In step 314, UE 301 receives the error indication and resets its own UDC compression memory (e.g. buffer 218 in FIG. 2). In step 315, UE 301 restarts UDC compression and generates a first compressed UDC data packet from the uncompressed packet queue (e.g., buffer 216 in FIG. 2). The first compressed UDC packet is saved in the compressed packet queue (e.g., buffer 217 in FIG. 2) to be transmitted over RLC AM bearer. In step 316, UE 301 transmits the first compressed UDC packet with reset indication to BS 302. In response to the reset indication, BS 302 resets its own UDC compression memory and performs normal checksum checking and UDC decompression accordingly.

FIG. 4 illustrates examples of a UDC data packet from a transmitter and a PDCP control PDU from a receiver for UDC error handling. The UDC data packet 410 is sent from the transmitter, which comprises an original network header 411, a new 1-byte UDC header 412, and data 413. The 1-byte UDC header 412 has one-byte length for byte-aligned network transmission. Within UDC header 412, FU bit is used to indicate whether the “data” part is processed by UDC. The FR bit is used to inform the receiver that the sender resets its compression memory. The checksum bits are used for compression memory synchronization check, which is only used if the FU bit is set. Data 413 contains compressed packets if the FU bit is set. The PDCP control PDU 420 is sent from the receiver upon detecting checksum mismatch. PDCP control PDU 420 comprises a PDU type, and one specific value of the PDU type can be used to indicate UDC error and checksum mismatch.

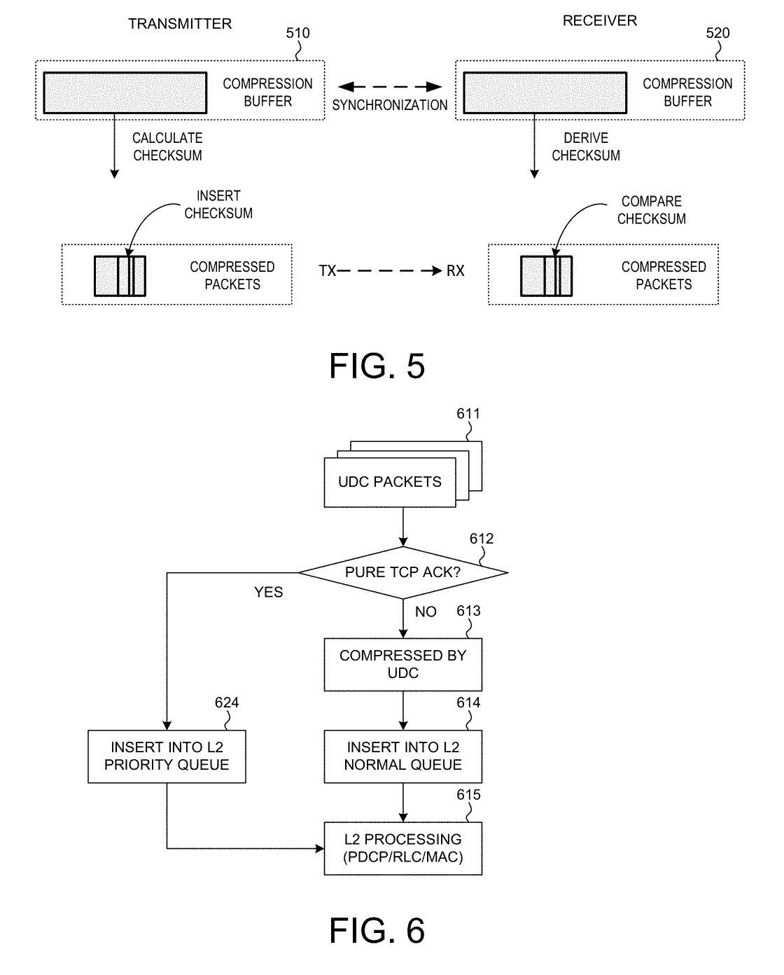

FIG. 5 illustrates UDC error handling procedure between a transmitter and a receiver through UDC checksum and UDC compression memory synchronization. Both transmitter and receiver maintain a compression buffer 510 and 520, respectively. When UDC is configured and initiated, the compression memory is synchronized, e.g., set to all 0's unless pre-defined dictionary is used. The UDC compression memory acts as a FIFO, the size is configured by RRC, and the input data is a stream of uncompressed packets. At the transmitter side, a checksum is calculated and inserted to each UDC compressed packet. For example, the last 4 bits of the sum of the last X byte in the compression memory 510 is used as the checksum, e.g., X=8. In another example, the checksum is derived from the values of the first 4 bytes and the last 4 bytes in the compression memory. The calculation is as follows: each byte is divided into two 4-bit numbers; the 16 6-bit numbers are added together to obtain a sum; and the checksum is one's complement of the right-most 4 bits (i.e., 4LSB) of the sum. At the receiver side, the receiver detects any checksum mismatch by comparing the received checksum from the UDC header of the compressed packets and the derived checksum from its own compression memory 520.

If checksum mismatch is detected, the receiver sends a PDCP control PDU with error notification to notify the sender that the compression memory is unsynchronized. Upon receiving the error notification, the sender resets its compression memory 510 to all zeros, and restarts UDC by generating a first compressed packet from the uncompressed packet queue. The sender then sets both the FU and FR bits in the UDC header of this first packet and transmits this packet to the receiver. The checksum in the UDC header of this packet is also set to zero (0) corresponding to the compression memory reset. Upon receiving the UDC packet with FR bit set, the receiver resets its compression memory 520 to all zeros for resynchronization and then performs checksum checking and UDC decompression as normal. After sending the error notification to the sender, the receiver may discard the compressed packets (i.e., where the FU bit is set) until the receiver receives the reset indication (i.e., where both the FU and FR bits are set).

The checksum mismatch may be detected either by the receiver or by the transmitter. When the receiver finds a checksum mismatch, it sends a PDCP control PDU to indicate the error, discards UDC packets with FU=1 and FR=0, and continues to process packet decompression from the first UDC packet with FU=1 and FR=1. When then sender receives the error notification, it discards all unsent compressed packets, resets compression memory, compresses from the start of the uncompressed packet queue, and sets FR=1 in the UDC header of the first compressed packet. Similarly, when the transmitter detects a checksum mismatch, it discards all unsent compressed packets, resets compression memory, compresses from the start of the uncompressed packet queue, and sets FR=1 in the UDC header of the first compressed packet. When the receiver receives the packet with FR=1, it resets its compression memory and processes the compressed packets as normal.

FIG. 6 illustrates one embodiment of TCP ACK packet prioritization with UDC bypass. TCP is a widely used transport layer protocol on top of IP packets. TCP throughput depends on TCP congestion control, whose behavior corresponds to the received TCP ACK packets. For certain packet type such as the TCP ACK packets, the delay due to asynchronous UDC compression memory may harm the TCP throughput while the gain from UDC compression is small. In accordance with one advantageous aspect, the application of UDC compression can be dynamically enabled or disabled. In step 611, when packets arrive at PDCP layer with UDC configured, the sender checks the packet type of each UDC packet (step 612). Normal packets are compressed by UDC (step 613), inserted into normal queue (step 614), and sent to L2 processing by PDCP/RLC/MAC (step 615). On the other hand, pure TCP ACK packets are inserted into priority queue and not processed by UDC (step 624), and sent to L2 processing by PDCP/RLC/MAC (step 615). Pure TCP ACK can be sent as fast as it arrives without affecting the UDC compression memory because it bypasses UDC. Asynchronous UDC compression memory will not influence the TCP ACK transmission and harm TCP throughput.

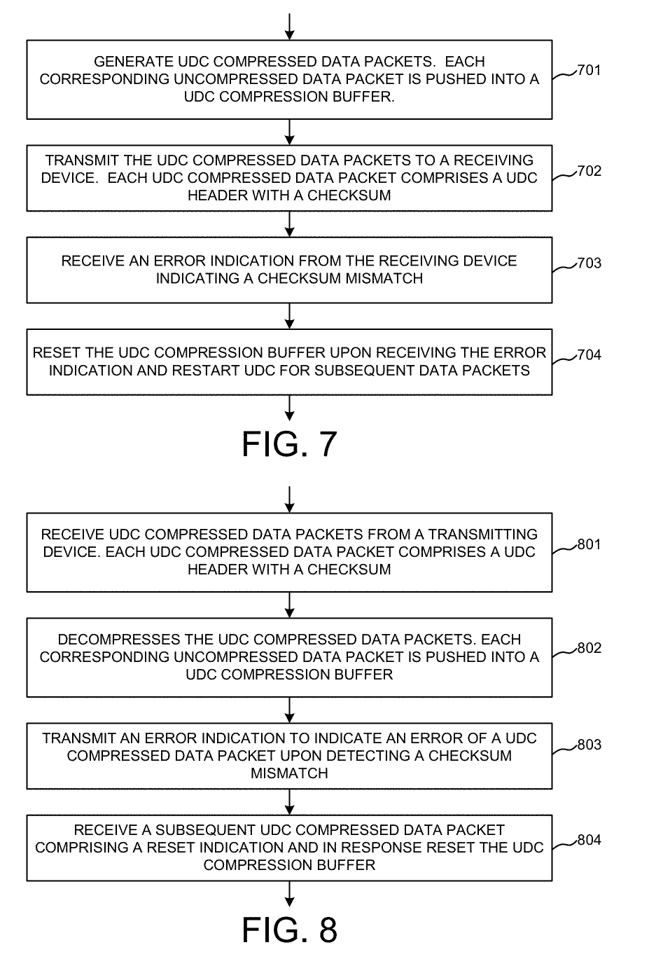

FIG. 7 is a flow chart of a method of UDC error handling from transmitter perspective in accordance with one novel aspect. In step 701, a transmitting device generates uplink data compression (UDC) compressed data packets. Each corresponding uncompressed data packet is pushed into a UDC compression buffer. In step 702, the device transmits the UDC compressed data packets to a receiving device. Each UDC compressed data packet comprises a UDC header with a checksum. In step 703, the device receives an error indication from the receiving device indicating a checksum mismatch. In step 704, the device resets the UDC compression buffer upon receiving the error indication and restarts UDC for subsequent data packets.

FIG. 8 is a flow chart of a method of UDC error handling from receiver perspective in accordance with one novel aspect. In step 801, a receiving device receives uplink data compression (UDC) compressed data packets. Each UDC compressed data packet comprises a UDC header with a checksum. In step 802, the device decompresses the UDC compressed data packets. Each corresponding uncompressed data packet is pushed into a UDC compression buffer. In step 803, the device transmits an error indication to indicate an error of a UDC compressed data packet upon detecting a checksum mismatch. In step 804, the device receives a subsequent UDC compressed data packet comprising a reset indication and in response resets the UDC compression buffer.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
generating uplink data compression (UDC) compressed data packets by a transmitting device, wherein each corresponding uncompressed data packet is pushed into a UDC compression buffer;
transmitting the UDC compressed data packets to a receiving device, wherein each UDC compressed data packet comprises a UDC header with a checksum;
receiving an error indication from the receiving device indicating a checksum mismatch; and
resetting the UDC compression buffer upon receiving the error indication and restarting UDC for subsequent data packets.

2. The method of claim 1, wherein each UDC compressed packet is a packet data convergence protocol (PDCP) packet to be transmitted over a radio link control (RLC) layer, a MAC layer, and a PHY layer.

3. The method of claim 1, wherein the checksum is derived from the UDC compression buffer.

4. The method of claim 1, wherein the UDC header further comprises a FR bit to indicate whether the transmitting device resets the UDC buffer.

5. The method of claim 4, wherein the transmitter sets the FR bit in a first UDC compressed data packet after the UDC compression buffer reset.

6. The method of claim 1, wherein the UDC header further comprises a FU bit to indicate whether a data packet is compressed by UDC.

7. The method of claim 6, further comprising:
determining whether a data packet needs to bypass UDC based on a packet type of the data packet.

8. A transmitting device, comprising:
an uplink data compression (UDC) compressor that compressed data packets, wherein each corresponding uncompressed data packet is pushed into a UDC compression buffer;
a transmitter that transmits the UDC compressed data packets to a receiving device, wherein each UDC compressed data packet comprises a UDC header with a checksum;
a receiver that receives an error indication from the receiving device indicating a checksum mismatch; and
a UDC compression buffer that is reset upon receiving the error indication and the transmitting device restarts UDC for subsequent data packets.

9. The device of claim 8, wherein each UDC compressed packet is a packet data convergence protocol (PDCP) packet to be transmitted over a radio link control (RLC) layer, a MAC layer, and a PHY layer.

10. The device of claim 8, wherein the checksum is derived from the UDC compression buffer.

11. The device of claim 8, wherein the UDC header further comprises a FR bit to indicate whether the transmitting device resets the UDC buffer.

12. The device of claim 11, wherein the transmitter sets the FR bit in a first UDC compressed data packet after the UDC compression buffer reset.

13. The device of claim 8, wherein the UDC header further comprises a FU bit to indicate whether a data packet is compressed by UDC.

14. The device of claim 13, further comprising:
determining whether a data packet needs to bypass UDC based on a packet type of the data packet.

15. A method, comprising:
receiving uplink data compression (UDC) compressed data packets by a receiving device, wherein each UDC compressed data packet comprises a UDC header with a checksum;
decompressing the UDC compressed data packets, wherein each corresponding uncompressed data packet is pushed into a UDC compression buffer;
transmitting an error indication to indicate an error of a UDC compressed data packet upon detecting a checksum mismatch; and
receiving a subsequent UDC compressed data packet comprising a reset indication and in response resetting the UDC compression buffer.

16. The method of claim 15, wherein each UDC compressed packet is a packet data convergence protocol (PDCP) packet to be received over a radio link control (RLC) layer, a MAC layer, and a PHY layer.

17. The method of claim 15, wherein the checksum mismatch is detected by comparing a first checksum received from the UDC compressed data packet and a second checksum derived from the UDC compression buffer.

18. The method of claim 15, wherein the receiving device discards UDC compressed data packets after sending the error indication and before receiving the reset indication.

19. The method of claim 15, wherein each UDC header further comprises a FR bit to indicate whether to reset the UDC compression buffer.

20. The method of claim 15, wherein each UDC header further comprises a FU bit to indicate whether a data packet is compressed by UDC.
